(19) United States
(12) Patent Application Publication
(10) Pub. No.: US 2026/0145937 A1
(43) Pub. Date: May 28, 2026

(54) MIXTURE OF SULFIDE SOLID ELECTROLYTE RAW MATERIALS AND METHOD FOR PRODUCING SULFIDE SOLID ELECTROLYTE

(71) Applicant: AGC Inc., Tokyo (JP)

(72) Inventors: Norifumi OMORI, Tokyo (JP); Yuji IMOTO, Tokyo (JP)

(73) Assignee: AGC Inc., Tokyo (JP)

(21) Appl. No.: 19/450,834

(22) Filed: Jan. 16, 2026

Related U.S. Application Data
(63) Continuation of application No. PCT/JP2024/025074, filed on Jul. 11, 2024.

(30) Foreign Application Priority Data
Jul. 21, 2023 (JP) 2023-119362

(51) Int. Cl. C01B 17/22; H01M 10/0525; H01M 10/0562

(52) U.S. Cl. CPC C01B 17/22; H01M 10/0562; C01P 2004/51; C01P 2004/61; C01P 2006/40; H01M 10/0525; H01M 2300/0068

(57) ABSTRACT

A mixture of sulfide solid electrolyte raw materials includes Li₂S and P₂S₅, and A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.

### CROSS-REFERENCE TO RELATED APPLICATIONS

This is a bypass continuation of International Application No. PCT/JP2024/025074 filed on Jul. 11, 2024, and claims priority from Japanese Patent Application No. 2023-119362 filed on Jul. 21, 2023, the entire content of which is incorporated herein by reference.

### TECHNICAL FIELD

The present invention relates to a mixture of sulfide solid electrolyte raw materials and a method for producing a sulfide solid electrolyte.

### BACKGROUND ART

Lithium ion secondary batteries are widely used in portable electronic devices such as a mobile phone and a notebook computer. In the related art, a liquid electrolyte has been used in a lithium ion secondary battery. On the other hand, in recent years, an all-solid-state lithium ion secondary battery in which a solid electrolyte is used as an electrolyte of the lithium ion secondary battery has attracted attention from the viewpoint that improvement of safety, high-speed charging and discharging, and a reduction in size of a case can be expected. Examples of the solid electrolyte used in the all-solid-state lithium ion secondary battery include a sulfide solid electrolyte.

In the case of producing the sulfide solid electrolyte by a melting method, aggregation of raw material particles may occur when the mixed raw materials are heated in a heating furnace. In particular, since P₂S₅, which is one of the raw materials, has a low melting point and the particles easily adhere to each other even at a low temperature, there is a problem that the raw material particles aggregate in a supply portion to the heating furnace, so that the supply portion is blocked and the mixed raw materials cannot be stably supplied to the heating furnace.

In contrast, for example, in Patent Literature 1, a composite compound containing lithium, phosphorus, and sulfur is synthesized in advance, and the composite compound is used as a raw material and heated and melted to prevent aggregation and clogging due to the raw material.

In Patent Literature 2, a solid raw material is heated while being compressed into a molten body to prevent volatilization of the raw material, thereby synthesizing a sulfide solid electrolyte while preventing aggregation and clogging due to the raw material.
Patent Literature 1: JP2012-043654A
Patent Literature 2: JP5640665B

### SUMMARY OF INVENTION

However, in the method disclosed in Patent Literature 1, since it is necessary to synthesize the composite compound in advance, production steps are complicated.

Patent Literature 2 does not describe low temperature aggregation of the raw material and does not solve the above problem. In addition, in the method disclosed in Patent Literature 2, since it is necessary to compress the raw material, the facility structure is very complicated, and thus it is difficult to produce a large number of solid electrolytes.

In view of the above, an object of the present invention is to provide a mixture of sulfide solid electrolyte raw materials, with which a sulfide solid electrolyte can be stably produced while preventing aggregation and clogging due to raw materials in producing a sulfide solid electrolyte by a melting method, and a method for producing a sulfide solid electrolyte using the mixture.

As a result of intensive studies, the present inventors have found that when an average particle diameter of Li₂S is set to be smaller than an average particle diameter of P₂S₅ in a mixture of sulfide solid electrolyte raw materials, it is possible to prevent aggregation and clogging during raw material supply and to stably produce a sulfide solid electrolyte, and have completed the present invention.

That is, an aspect of the present invention relates to a mixture of sulfide solid electrolyte raw materials containing Li₂S and P₂S₅, in which A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.

Another aspect of the present invention relates to a method for producing a sulfide solid electrolyte including: charging sulfide solid electrolyte raw materials into a heated furnace and performing mixing to obtain a mixture of sulfide solid electrolyte raw materials, or charging a mixture of sulfide solid electrolyte raw materials into a heated furnace; and heating and melting the mixture of sulfide solid electrolyte raw materials, and cooling and solidifying resulting melt to obtain a sulfide solid electrolyte, in which the mixture of sulfide solid electrolyte raw materials contains Li₂S and P₂S₅, and A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.

According to the present invention, it is possible to prevent aggregation and clogging due to sulfide solid electrolyte raw materials during supply, and to stably produce a sulfide solid electrolyte.

### BRIEF DESCRIPTION OF DRAWINGS

FIG. 1 is a flow diagram showing a method for producing a sulfide solid electrolyte according to the present embodiment.

FIG. 2A is a photomicrograph of a mixture in Example 1.

FIG. 2B is a photomicrograph of a mixture in Example 4.

FIG. 3 is a schematic diagram of an apparatus for measuring a temperature at the time of clogging in Examples.

### DESCRIPTION OF EMBODIMENTS

Hereinafter, the present invention is described in detail, but the present invention is not limited to the following embodiment, and can be freely modified and implemented without departing from the gist of the present invention.

“To” indicating a numerical range is used to include numerical values written before and after it as a lower limit value and an upper limit value.

### <<Mixture of Sulfide Solid Electrolyte Raw Materials>>

A mixture of sulfide solid electrolyte raw materials according to the present embodiment is a mixture of sulfide solid electrolyte raw materials containing Li₂S and P₂S₅, in which A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.

Mixture of Sulfide Solid Electrolyte Raw Materials Containing Li₂S and P₂S₅

The mixture (hereinafter, also referred to as the present mixture) of sulfide solid electrolyte raw materials containing Li₂S and P₂S₅ (hereinafter, also referred to as the present raw materials) satisfies A<B, where A is a volume-based average particle diameter of Li₂S contained in the present mixture as measured by using a laser diffraction particle size distribution measurement method, and B is a volume-based average particle diameter of P₂S₅ contained in the present mixture as measured by using the laser diffraction particle size distribution measurement method. Accordingly, as shown in FIG. 2A, a large amount of Li₂S particles can be brought into contact with surfaces of P₂S₅ particles in the present mixture, or the surfaces of the P₂S₅ particles can be coated with the Li₂S particles. Accordingly, it is believed that the contact between the P₂S₅ particles is prevented and the Li₂S particles having a relatively high melting point come into contact with each other, so that aggregation of the raw material particles can be prevented, and thus clogging of a supply portion or the like can be prevented.

It is presumed that this is because, by setting the particle diameter of Li₂S to be smaller than the particle diameter of P₂S₅, the Li₂S particles easily enter gaps around the P₂S₅ particles, and it is possible to bring a large amount of Li₂S particles into contact with the surfaces of the P₂S₅ particles or to coat the surfaces of the P₂S₅ particles with the Li₂S particles.

By setting the average particle diameter of P₂S₅ to be larger than the average particle diameter of Li₂S, scattering of P₂S₅ after charging into the heating furnace can be prevented, and thus it is possible to prevent volatilization of P₂S₅ due to contact with a furnace wall.

The A is preferably 0.1 μm to 50 μm. The A is preferably 0.1 μm or more, still more preferably 1 μm or more, and particularly preferably 2 μm or more. The A is more preferably 50 μm or less, still more preferably 40 μm or less, and particularly preferably 30 μm or less.

The B is preferably 50 μm or more (B≥50 μm), more preferably 75 μm or more, still more preferably 100 μm or more, and particularly preferably 150 μm or more. The B is more preferably 2,000 μm or less, still more preferably 1,750 μm or less, and particularly preferably 1,500 μm or less. The B may be 50 μm to 2,000 μm.

2.5 The ratio (A/B) of the A to the B is preferably 0.5 or less (A/B≤0.5). The A/B is more preferably 0.4 or less, and particularly preferably 0.3 or less. The A/B is more preferably 0.0025 or more, still more preferably 0.005 or more, and particularly preferably 0.0075 or more. The A/B may be 0.0025 to 0.5.

The volume-based average particle diameters of Li₂S and P₂S₅ as measured by using the laser diffraction particle size distribution measurement method can be measured using, for example, MT3000II (manufactured by Microtrac). The average particle diameter means a D50 in a volume-based particle diameter distribution as measured by using the laser diffraction particle size distribution measurement method.

The present mixture preferably contains a lithium halide (LiHa) to be described later. That is, the present mixture is preferably obtained by mixing a powder of Li₂S, a powder of P₂S₅, and a powder of LiHa as one of the raw materials contained in the present raw materials.

In this case, a volume-based average particle diameter of the powder of LiHa as measured by using the laser diffraction particle size distribution measurement method is preferably 0.1 μm to 2,000 μm. The average particle diameter is preferably 0.1 μm or more, still more preferably 1 μm or more, and particularly preferably 2 μm or more. The average particle diameter is more preferably 2,000 μm or less, still more preferably 1,750 μm or less, and particularly preferably 1,500 μm or less.

As the present raw materials, as long as Li₂S and P₂S₅ described above are contained, one or a plurality of other various raw materials can be used, and the sulfide solid electrolyte obtained using these raw materials may also be various sulfide solid electrolytes.

Each raw material contained in the present raw materials may be synthesized, or a commercially available product may be used. Each raw material may be powdery, and the present raw materials containing the raw material may also be powdery. Further, the present raw materials may each be subjected to a known pretreatment. That is, the production method according to the present embodiment may appropriately include, as a step 0, which is a step of preparing the present raw materials, at least one of a step of producing the present raw materials and a step of performing a pretreatment on at least a part of the present raw materials before a step S1.

The sulfide solid electrolyte raw materials containing Li₂S and P₂S₅ may be appropriately determined depending on a composition of the desired sulfide solid electrolyte.

One of the raw materials contained in the present raw materials includes, for example, a substance such as an alkali metal element (R) and a sulfur element(S). Examples of the alkali metal element (R) include a lithium element (Li), a sodium element (Na), and a potassium element (K). In the case where the sulfide solid electrolyte is applied to a lithium ion secondary battery, the alkali metal element (R) preferably contains a substance such as a lithium element (Li).

As an alkali metal element (R) source, substances containing an alkali metal element such as an elemental alkali metal element and compounds containing an alkali metal element can be appropriately combined and used. In the case where the alkali metal element (R) is a lithium element (Li), a Li-containing substance such as elemental Li or a Li-containing compound can be appropriately used in combination as a lithium element source. As described above, the present raw materials contain at least Li₂S, which can be the lithium element (Li) source.

Examples of the lithium element (Li)-containing substance include lithium compounds such as lithium iodide (LiI), lithium carbonate (Li₂CO₃), lithium sulfate (Li₂SO₄), lithium oxide (Li₂O), and lithium hydroxide (LiOH) in addition to lithium sulfide (Li₂S) descried above, and metal lithium. The lithium element (Li)-containing substance may be used alone or in combination of two or more kinds thereof.

As the lithium element (Li)-containing substance, it is preferable to use lithium sulfide from the viewpoint of obtaining a sulfide material. In the case where the obtained sulfide solid electrolyte contains a halogen element, a lithium halide (LiHa, Ha is a halogen element) is also preferably contained as the lithium element (Li)-containing substance. The lithium halide is to be described later.

As a sulfur element(S) source, S-containing substances such as elemental S and a S-containing compound can be appropriately combined and used. The sulfur element(S)-containing substance may be used alone or in combination of two or more kinds thereof. As described above, the present raw materials contain at least Li₂S and P₂S₅, which can be the sulfur element(S) source. Li₂S is a compound serving as both the sulfur element(S)-containing substance and the lithium element (Li)-containing substance described above. P₂S₅ is a compound serving as both the sulfur element(S)-containing substance and a phosphorus element (P)-containing substance to be described later.

Examples of the sulfur element(S)-containing substance include phosphorus sulfides such as phosphorus trisulfide (P₂S₃) in addition to phosphorus pentasulfide (P₂S₅), other sulfur compounds containing phosphorus, elemental sulfur, and a sulfur-containing compound. Examples of the sulfur-containing compound include H₂S, CS₂, iron sulfides (such as FeS, Fe₂S₃, FeS₂, and Fe₁₋ₓS), bismuth sulfide (Bi₂S₃), and copper sulfides (such as CuS, Cu₂S, and Cu₁₋ₓS).

From the viewpoint of improving an ion conductivity and the like of the obtained sulfide solid electrolyte, it is preferable that the present raw materials further contain a phosphorus element (P). As a phosphorus element (P) source, P-containing substances such as elemental P and a P-containing compound can be appropriately combined and used. The phosphorus element (P)-containing substance may be used alone or in combination of two or more kinds thereof. As described above, the present raw materials contain at least P₂S₅, which can be the phosphorus element (P) source.

Examples of the phosphorus element (P)-containing substance include phosphorus sulfides such as phosphorus trisulfide (P₂S₃) in addition to phosphorus pentasulfide (P₂S₅) described above, phosphorus compounds such as sodium phosphate (Na₃PO₄), and elemental phosphorus.

The mixing ratio of the present raw materials is not particularly limited. For example, a molar ratio S/R of the sulfur element(S) to the alkali metal element (R) in the present mixture is preferably 0.65/0.35 or less, and more preferably 0.5/0.5 or less, from the viewpoint of improving the ion conductivity and the like of the obtained sulfide solid electrolyte.

The present mixture is preferably obtained by mixing at a predetermined stoichiometric ratio according to the present raw materials.

A mixing method for mixing the present raw materials to obtain the present mixture is not particularly limited, and examples thereof include mixing in a mortar, mixing using a medium such as a planetary ball mill, and medium-less mixing such as a pin mill, a powder stirrer, and air flow mixing.

Examples of a combination of the alkali metal element-containing substance and the sulfur element-containing substance when mixing the present raw materials include a combination of Li₂S and P₂S₅, and a combination of Li₂S, P₂S₅, and LiHa in the case where the obtained sulfide solid electrolyte contains a halogen element as a constituent element.

In the combination of Li₂S and P₂S₅, a molar ratio Li/P of Li to P is preferably 40/60 to 88/12, and more preferably 50/50 to 88/12. When the mixing ratio or the charging ratio is adjusted such that the amount of P₂S₅ is relatively smaller than the amount of Li₂S, it is easier to prevent volatilization of the sulfur component and the phosphorus component during a heat treatment due to a lower boiling point of P₂S₅ compared to a melting point of Li₂S.

On the other hand, since lithium sulfide is expensive, a lithium compound other than lithium sulfide, metal lithium, or the like may be used in addition to lithium sulfide, from the viewpoint of reducing a production cost of the sulfide solid electrolyte.

In this case, the raw material may include a Li-containing substance, such as metal lithium, a lithium halide (LiHa), lithium carbonate (Li₂CO₃), lithium sulfate (Li₂SO₄), lithium oxide (Li₂O), or lithium hydroxide (LiOH). These may be used alone or in combination of two or more kinds thereof.

The present raw materials may further contain substances (compounds and the like) in addition to the above substances depending on the composition of the target sulfide solid electrolyte or as additives or the like. For example, in the case of producing a sulfide solid electrolyte containing a halogen element such as F, Cl, Br or I, the raw materials preferably contain a halogen element (Ha). In this case, a halogen element-containing compound is preferably contained as the present raw materials.

Examples of the halogen element-containing compound include lithium halides such as lithium fluoride (LiF), lithium chloride (LiCl), lithium bromide (LiBr), and lithium iodide (LiI), a phosphorus halide, a phosphoryl halide, a sulfur halide, a sodium halide, and a boron halide. Among these, from the viewpoint of reactivity, a lithium halide is preferred, LiCl, LiBr, and LiI are more preferred, and LiCl and LiBr are still more preferred. These compounds may be used alone or in combination of two or more kinds thereof.

An alkali metal halide such as a lithium halide is also a compound containing an alkali metal element such as Li, and thus can be the alkali metal element (R) source in the present raw materials.

In the case where the present mixture contains the halogen element (Ha) and the phosphorus element (P), a molar equivalent of the halogen element (Ha) to the phosphorus element (P) in the present mixture is preferably 0.2 to 4 molar equivalents, and more preferably 0.5 to 3 molar equivalents. Here, the molar equivalent of the halogen element is preferably 0.2 molar equivalents or more, and more preferably 0.5 molar equivalents or more, from the viewpoint of improving the ion conductivity and the like of the obtained sulfide solid electrolyte. The molar equivalent of the halogen element is preferably 4 molar equivalents or less, and more preferably 3 molar equivalents or less, from the viewpoint of stability of the obtained sulfide solid electrolyte. In the case where the powder raw material contains two or more kinds of halogen elements, a total content thereof preferably satisfies the above molar equivalent range.

In the case where the sulfide solid electrolyte to be obtained using the present mixture has an amorphous phase, it is preferable to contain a sulfide such as SiS₂, B₂S₃, GeS₂, or Al₂S₃ as the present raw materials from the viewpoint of easily forming an amorphous phase and reducing a facility load even when a rapid cooling rate during rapid cooling is reduced. These may be used alone or in combination of two or more kinds thereof.

From the viewpoint of imparting moisture resistance to the sulfide solid electrolyte to be obtained using the present mixture, it is preferable to contain an oxide such as SiO₂, B₂O₃. GeO₂, Al₂O₃, or P₂O₅ as the present raw materials. These may be used alone or in combination of two or more kinds thereof.

A content of the sulfide and the oxide is preferably 0.1 mass % to 50 mass %, and more preferably 0.5 mass % to 40 mass %, with respect to a total of the present raw materials. Here, the content is preferably 0.1 mass % or more, more preferably 0.5 mass % or more, and is preferably 50 mass % or less, more preferably 40 mass % or less.

The present mixture may further contain a compound to be a crystal nucleus to be described later.

The present embodiment has an object of preventing aggregation and clogging due to a low melting point of P₂S₅ and easy adhesion of the particles to each other even at a low temperature, but also has an effect of preventing the aggregation and clogging due to a compound having a low melting point other than P₂S₅. Examples of the compound having a low melting point other than P₂S₅ include LiI, B₂S₃, S, Se, and Sb₂S₃. Therefore, the present mixture is also effective in producing a sulfide solid electrolyte using the present raw materials containing the compound having a low melting point together with P₂S₅.

### <<Method for Producing Sulfide Solid Electrolyte>>

A production method according to the present embodiment is a method for producing a sulfide solid electrolyte including: charging sulfide solid electrolyte raw materials into a heated furnace and performing mixing to obtain a mixture of sulfide solid electrolyte raw materials, or charging a mixture of sulfide solid electrolyte raw materials into a heated furnace; and heating and melting the mixture of sulfide solid electrolyte raw materials, and cooling and solidifying resulting melt to obtain a sulfide solid electrolyte, in which the mixture of sulfide solid electrolyte raw materials contains Li₂S and P₂S₅, and A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.

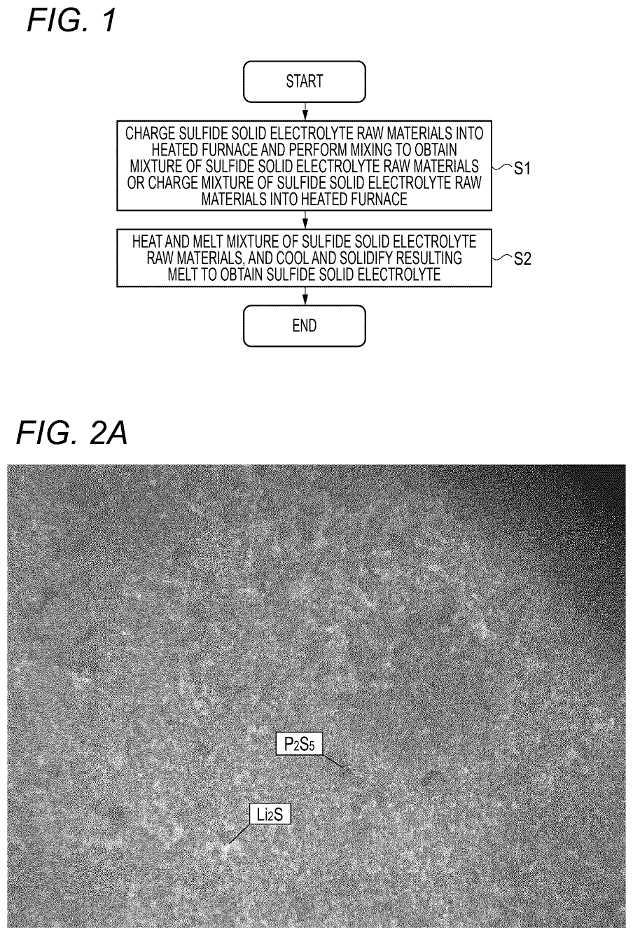

As shown in FIG. 1, the production method according to the present embodiment includes the following steps.
(Step S1) a step of charging sulfide solid electrolyte raw materials into a heated furnace and performing mixing to obtain a mixture of sulfide solid electrolyte raw materials, or a step of charging a mixture of sulfide solid electrolyte raw materials into a heated furnace
(Step S2) a step of heating and melting the mixture of sulfide solid electrolyte raw materials, and cooling and solidifying resulting melt to obtain a sulfide solid electrolyte Hereinafter, each step is described.
   <Step S1: Step of Charging Sulfide Solid Electrolyte Raw Materials into Heated Furnace and Performing Mixing to Obtain Mixture of Sulfide Solid Electrolyte Raw Materials, or Step of Charging Mixture of Sulfide Solid Electrolyte Raw Materials into Heated Furnace>

In the production method according to the present embodiment, sulfide solid electrolyte raw materials or a mixture of sulfide solid electrolyte raw materials is charged into a heated furnace. Here, “charging the sulfide solid electrolyte raw materials or the mixture of sulfide solid electrolyte raw materials into the heated furnace” means that the charging of the sulfide solid electrolyte raw materials or the mixture of sulfide solid electrolyte raw materials may be started in a state where the furnace is heated, or the heating of the furnace may be started during the charging of the sulfide solid electrolyte raw materials or the mixture of sulfide solid electrolyte raw materials.

A temperature of the heated furnace is preferably 500° C. to 1,000° C., for example. The temperature of the heated furnace is preferably 500° C. or higher, more preferably 550° C. or higher, particularly preferably 600° C. or higher, and is preferably 1,000° C. or lower, more preferably 950° C. or lower, particularly preferably 900° C. or lower.

As the furnace in the heating furnace for use in the heating and melting, a well known furnace including a heating unit can be appropriately used, and a material and a size of the furnace can be freely selected.

In the step S1, the sulfide solid electrolyte raw materials may be charged into the heated furnace and mixed to obtain a mixture of sulfide solid electrolyte raw materials, or a mixture of sulfide solid electrolyte raw materials may be charged into the heated furnace. Here, the sulfide solid electrolyte raw materials and the mixture of sulfide solid electrolyte raw materials mean the sulfide solid electrolyte raw materials and the mixture of sulfide solid electrolyte raw materials described above in <<Mixture of Sulfide Solid Electrolyte Raw Materials>>.

Among these, from the viewpoint of improving homogeneity of the obtained sulfide solid electrolyte, it is preferable to charge the present mixture into the heating furnace and perform heating and melting to be described later.

In the case of charging the present raw materials into the heating furnace to obtain the present mixture and then performing heating and melting to be described later, for example, the charging ratio of the present raw materials may be appropriately determined according to the composition of the target sulfide solid electrolyte. In the case of charging the present mixture obtained by mixing the present raw materials into the heating furnace and then performing heating and melting to be described later, for example, the mixing ratio of the present raw materials may be appropriately determined according to the composition of the target sulfide solid electrolyte.

### <Step S2: Step of Heating and Melting Mixture of Sulfide Solid Electrolyte Raw Materials, and Cool and Solidify Resulting Melt to Obtain Sulfide Solid Electrolyte>

### Heating and Melting

In the step S2 in the present embodiment, the present raw materials or the present mixture is charged into the heating furnace, the present raw materials are mixed as necessary to obtain the present mixture, and then the present mixture is heated and melted.

A temperature in the heating and melting is not particularly limited as long as the present mixture is melted, and is preferably 600° C. or higher, more preferably 600° C. to 1,000° C., still more preferably 630° C. to 950° C., even more preferably 650° C. or higher and lower than 900° C., and particularly preferably 650° C. or higher and lower than 850° C. Here, the temperature in the heating and melting preferably 600° C. or higher, more preferably 630° C. or higher, and still more preferably 650° C. or higher, from the viewpoint of homogenizing the melt in a short time. The temperature in the heating and melting is preferably 1,000° C. or lower, more preferably 950° C. or lower, still more preferably lower than 900° C., and particularly preferably lower than 850° C., from the viewpoint of preventing deterioration or decomposition of components in the melt.

The temperature in the heating and melting is the temperature of the melt generated in the furnace, and can be adjusted by the heating unit provided in the furnace.

A time for the heating and melting is not particularly limited as long as the present mixture is melted, and may be, for example, 0.5 hours or longer, 1 hour or longer, or 2 hours or longer.

A pressure during the heating and melting is not particularly limited as long as the present mixture is melted, and for example, a normal pressure or a slight pressure is preferred, and a normal pressure is more preferred.

From the viewpoint of preventing side reactions of the melt with water vapor, oxygen, and the like during the heating and melting, a dew point in the furnace is preferably −20° C. or lower. A lower limit of the dew point is not particularly limited, and is generally −80° C. or higher. An oxygen concentration in the furnace is preferably 1,000 ppm by volume or less.

The heating and melting is preferably performed in a sulfur element-containing gas atmosphere. By heating and melting the present mixture in the sulfur element-containing gas atmosphere, sulfur is introduced into the obtained melt, making it possible to prevent a change in sulfur composition due to volatilization. Examples of the sulfur element-containing gas include a gas containing a compound containing the sulfur element or elemental sulfur, such as a sulfur gas, a hydrogen sulfide gas, and a carbon disulfide gas.

The sulfur element-containing gas atmosphere may be obtained by supplying a sulfur source into the melt obtained by heating and melting the present mixture and heating the sulfur source to generate a sulfur element-containing gas. In this case, the sulfur source is not particularly limited as long as it is elemental sulfur or a sulfur compound from which the sulfur element-containing gas can be obtained by heating, and examples thereof include elemental sulfur, organic sulfur compounds such as hydrogen sulfide and carbon disulfide, iron sulfides (such as FeS, Fe₂S₃, FeS₂, and Fe₁₋ₓS), bismuth sulfide (Bi₂S₃), copper sulfides (such as CuS, Cu₂S, and Cu₁₋ₓS), polysulfides such as lithium polysulfide and sodium polysulfide, polysulfides, and a rubber subjected to a sulfur vulcanization treatment. The sulfur source is preferably a sulfur powder.

As another method, the sulfur element-containing gas atmosphere may be obtained by introducing a sulfur vapor obtained in advance into the furnace. For example, sulfur is heated at 200° C. to 450° C. to generate a sulfur vapor, and an inert gas such as a N₂ gas, an argon gas, or a helium gas is used as a carrier gas to transport the sulfur vapor into the furnace to obtain the sulfur element-containing gas atmosphere.

As still another method, the sulfur element-containing gas atmosphere may be obtained by incorporating the sulfur source into the present mixture. Accordingly, when heating and melting the present mixture, the sulfur source is also heated, so that the present raw materials can be heated and melted in the generated sulfur element-containing gas atmosphere.

In the present production method, for obtaining the above sulfur element-containing gas atmosphere, any one of the methods may be used, or a plurality of methods may be used in combination.

### Cooling and Solidification

Subsequently, the melt obtained by the heating and melting is cooled and solidified to obtain a sulfide solid electrolyte. By cooling the melt, a solid sulfide solid electrolyte is obtained.

The melt obtained by the heating and melting is discharged through a discharge port provided in the furnace at any timing, and the production method proceeds to a step of cooling and solidifying the melt. The cooling of the melt can be performed by a known method and is not particularly limited. For example, from the viewpoint of increasing a cooling rate, cooling using a twin roller, which is generally said to have the highest rapid cooling rate, is preferred.

The cooling rate is preferably 0.01° C./sec or more, more preferably 0.05° C./sec or more, and still more preferably 0.1° C./sec or more, from the viewpoint of maintaining the composition of the obtained melt. The upper limit value of the cooling rate is not particularly limited, and the cooling rate of the twin roller is, for example, 1,000,000° C./sec or less.

When it is desired to obtain an amorphous sulfide solid electrolyte, it is preferable to perform rapid cooling at a higher cooling rate. The cooling rate during the rapid cooling is preferably 10° C./sec or more, more preferably 100° C./sec or more, still more preferably 500° C./sec or more, and particularly preferably 700° C./sec or more. The upper limit value of the cooling rate during the rapid cooling is not particularly limited, and the cooling rate of the twin roller is, for example, 1,000,000° C./sec or less.

On the other hand, a sulfide solid electrolyte having a crystal phase may be obtained by slow cooling in the cooling and solidification step. The sulfide solid electrolyte may have a crystal phase and an amorphous phase.

A cooling rate in the case of the slow cooling is preferably 0.01° C./sec to 500° C./sec, and more preferably 0.05° C./sec to 450° C./sec. The cooling rate may be 0.01° C./sec to 10° C./sec or 0.05° C./sec to 5° C./sec.

Here, the cooling rate is preferably 0.01° C./sec or more, more preferably 0.05° C./sec or more, and is preferably 500° C./sec or less, more preferably 450° C./sec or less. The cooling rate may be 10° C./sec or less or 5° C./sec or less. The cooling rate may be appropriately adjusted according to crystallization conditions.

A crystal of the sulfide solid electrolyte is preferably an ion conductive crystal. Specifically, in the case where a carrier is a lithium ion, the ion conductive crystal is preferably a crystal having a lithium ion conductivity of more than 1.0×10⁻⁴ S/cm, and the lithium ion conductivity is more preferably more than 1.0×10⁻³ S/cm.

When it is desired to obtain the sulfide solid electrolyte having a crystal phase, it is preferable to contain a compound to be a crystal nucleus in the melt in order to facilitate precipitation of crystals.

The method of incorporating the compound to be a crystal nucleus into the melt is not particularly limited, and examples thereof include a method of adding the compound to be a crystal nucleus to the present mixture in the step S1, and a method of directly adding the compound to be a crystal nucleus to the melt during the heating and melting.

Examples of the compound to be a crystal nucleus include oxides, oxynitrides, nitrides, carbides, other chalcogen compounds, and halides. The compound to be a crystal nucleus is preferably a compound having a certain degree of compatibility with the melt. A compound completely incompatible with the melt cannot serve as a crystal nucleus.

An addition amount of the compound to be a crystal nucleus with respect to the melt is preferably 0.01 mass % to 20 mass %, more preferably 0.1 mass % to 20 mass %, and still more preferably 1 mass % to 10 mass %. Here, the addition amount is preferably 0.01 mass % or more, more preferably 0.1 mass % or more, and still more preferably 1 mass % or more, from the viewpoint of suitably forming a crystal phase in the obtained sulfide solid electrolyte. The addition amount is preferably 20 mass % or less, and more preferably 10 mass % or less, from the viewpoint of preventing a decrease in lithium ion conductivity.

When it is desired to obtain a sulfide solid electrolyte having a large amount of an amorphous phase, the compound to be a crystal nucleus is not added to the melt, or even when the compound is added, the addition amount is preferably 1 mass % or less, and more preferably 0.1 mass % or less. The addition amount may be 0.01 mass % or less.

The cooling and solidification is preferably performed under a normal pressure. The normal pressure means that the pressure is not controlled during the cooling. Specifically, the pressure is about 0.8 atm to 1.2 atm.

In the production method according to the present embodiment, the sulfide solid electrolyte obtained in the step S2 may be heated again for a heat treatment. In the case where the sulfide solid electrolyte is amorphous or has an amorphous phase, the heat treatment may be particularly performed.

The lithium ion conductivity may be increased by rearranging ions in the crystal structure by the heat treatment.

The heat treatment refers to at least one of a heat treatment for crystallizing the obtained solid and a heat treatment for rearranging the ions in the crystal structure. That is, the heat treatment also includes a crystallization treatment by heating the amorphous sulfide solid electrolyte or the sulfide solid electrolyte having an amorphous phase.

In the production method according to the present embodiment, the step S1 and the step S2 are preferably performed as a continuous process. That is, it is preferable to continuously obtain the sulfide solid electrolyte by continuously charging the present raw materials or the present mixture into the furnace, mixing the present raw materials as necessary to obtain the present mixture, then heating and melting the present mixture, and thereafter shifting to a step of continuously discharging the obtained melt and cooling and solidifying the melt. In this manner, it is preferable to continuously produce the sulfide solid electrolyte.

By continuously producing the sulfide solid electrolyte, a series of steps of heating and melting the present mixture, and discharging and cooling and solidifying the melt are continuously performed, and a large number of sulfide solid electrolytes can be produced more efficiently in a short time.

In a more preferred embodiment of the continuous process, first, the present mixture is heated and melted in an amount that allows an amount of the melt obtained by heating and melting the present mixture to form at least a melt surface in the furnace. Here, the melt surface means a liquid surface formed by the melt covering the entire bottom surface of the furnace. Once the melt surface is formed in the furnace, the present raw materials or the present mixture to be additionally charged into the melt undergoes a rapid increase in temperature and is instantaneously melted. Therefore, according to the addition of the present raw materials or the present mixture, the melt is continuously and successively generated, and the melt is continuously discharged and subjected to the cooling and solidification step, whereby the sulfide solid electrolyte is continuously obtained in a short time.

By continuous production of the sulfide solid electrolyte, a large number of sulfide solid electrolytes can be produced in a short time. The volatilization of the raw materials in the production steps can be prevented with the shortening in time of the production steps.

In the production method according to the present embodiment, the processes in the step S1 and the step S2 may be performed in a batch manner. The batch manner is a method in which the sulfide solid electrolyte raw materials or a mixture thereof is charged into a furnace, and then heated and melted to discharge the whole amount, and means a method in which all contents in the furnace are replaced every time the production method according to the present embodiment is performed.

### <Sulfide Solid Electrolyte>

Examples of the sulfide solid electrolyte obtained by the production method according to the present embodiment include a sulfide solid electrolyte containing elements of Li, P, and S, for example, a sulfide solid electrolyte having an LGPS crystal structure such as Li₁₀GeP₂S₁₂, a sulfide solid electrolyte having an argyrodite crystal structure such as Li₆PS₅Cl, Li_{5.4}PS_{4.4}Cl_{1.6}, and Li_{5.4}PS_{4.4}Cl_{0.8}Br_{0.8}, a Li—P—S-Ha-based (Ha represents at least one element selected from halogen elements) crystallized glass, and an LPS crystallized glass such as Li₇P₃S₁₁.

Depending on the purpose, the sulfide solid electrolyte may be an amorphous sulfide solid electrolyte, a sulfide solid electrolyte having a specific crystal structure, or a sulfide solid electrolyte having a crystal phase and an amorphous phase. The crystal phase is more preferably an argyrodite crystal phase from the viewpoint of the lithium ion conductivity.

From the viewpoint of the lithium ion conductivity, a sulfide solid electrolyte containing elements of Li, P, S, and Ha is preferred, and a sulfide solid electrolyte having a crystal phase is more preferred. The halogen element is preferably derived from one or more selected from the group consisting of lithium chloride, lithium bromide, and lithium iodide.

The lithium ion conductivity of the sulfide solid electrolyte is preferably 1.0×10⁻⁴ S/cm or more, more preferably 5.0×10⁻⁴ S/cm or more, still more preferably 1.0×10⁻³ S/cm or more, and particularly preferably 5.0×10⁻³ S/cm or more, from the viewpoint of battery properties when used in a lithium ion secondary battery.

The lithium ion conductivity in the present description is a value measured using an AC impedance measurement apparatus (for example, potentiostat/galvanostat VSP, manufactured by Bio-Logic Sciences Instruments) under the following conditions: measurement frequency: 100 Hz to 1 MHz, measurement voltage: 100 mV, measurement temperature: 25° C.

The obtained sulfide solid electrolyte can be identified by analyzing the crystal structure by X-ray diffraction (XRD) measurement, and analyzing the elemental composition using various methods such as ICP emission spectrometry, atomic absorption spectrometry, and ion chromatography. For example, P and S can be measured by ICP emission spectrometry, Li can be measured by atomic absorption spectrometry, and Ha can be measured by ion chromatography.

The present invention is not limited to the above embodiment, and various modifications can be adopted within the scope of the present invention. For example, the present invention is not limited to the above embodiment, and may be modified and improved as appropriate. In addition, the material, shape, size, number, arrangement place, and the like of each component in the above embodiment are optional as long as the present invention can be achieved, and are not limited.

As described above, the following matters are disclosed in the present description.
1. A mixture of sulfide solid electrolyte raw materials including Li₂S and P₂S₅,
   in which A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.
2. The mixture of sulfide solid electrolyte raw materials according to the above 1, in which A/B≤0.5 is satisfied.
3. The mixture of sulfide solid electrolyte raw materials according to the above 1 or 2, in which B≥50 μm is satisfied.
4. A method for producing a sulfide solid electrolyte, including:
   charging sulfide solid electrolyte raw materials into a heated furnace and performing mixing to obtain a mixture of the sulfide solid electrolyte raw materials, or charging a mixture of sulfide solid electrolyte raw materials into a heated furnace; and
   heating and melting the mixture of sulfide solid electrolyte raw materials, and cooling and solidifying a resulting melt to obtain a sulfide solid electrolyte,
   in which the mixture of sulfide solid electrolyte raw materials includes Li₂S and P₂S₅, and
   A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.
5. The method for producing a sulfide solid electrolyte according to the above 4, in which A/B≤0.5 is satisfied.
6. The method for producing a sulfide solid electrolyte according to the above 4 or 5, in which B≥50 μm is satisfied.
7 The method for producing a sulfide solid electrolyte according to any one of the above 4 to 6, in which the sulfide solid electrolyte raw materials or the mixture of sulfide solid electrolyte raw materials is continuously charged into the heated furnace, heated and melted, and the resulting melt is continuously discharged to continuously obtain the sulfide solid electrolyte.
8. The method for producing a sulfide solid electrolyte according to any one of the above 4 to 7, in which a sulfur source is supplied into the melt obtained by heating and melting the mixture of sulfide solid electrolyte raw materials.
9. The method for producing a sulfide solid electrolyte according to any one of the above 4 to 8, in which a sulfur source is incorporated into the mixture of sulfide solid electrolyte raw materials, followed by heating and melting.
10. The method for producing a sulfide solid electrolyte according to any one of the above 4 to 9, in which the mixture of sulfide solid electrolyte raw materials is heated and melted at 600° C. or higher.

### EXAMPLES

Hereinafter, the present invention is specifically described with reference to Examples, but the present invention is not limited thereto. Examples 1 and 2 are Inventive Examples, and Examples 3 and 4 are Comparative Examples.

<Temperature when Clogging Occurs>

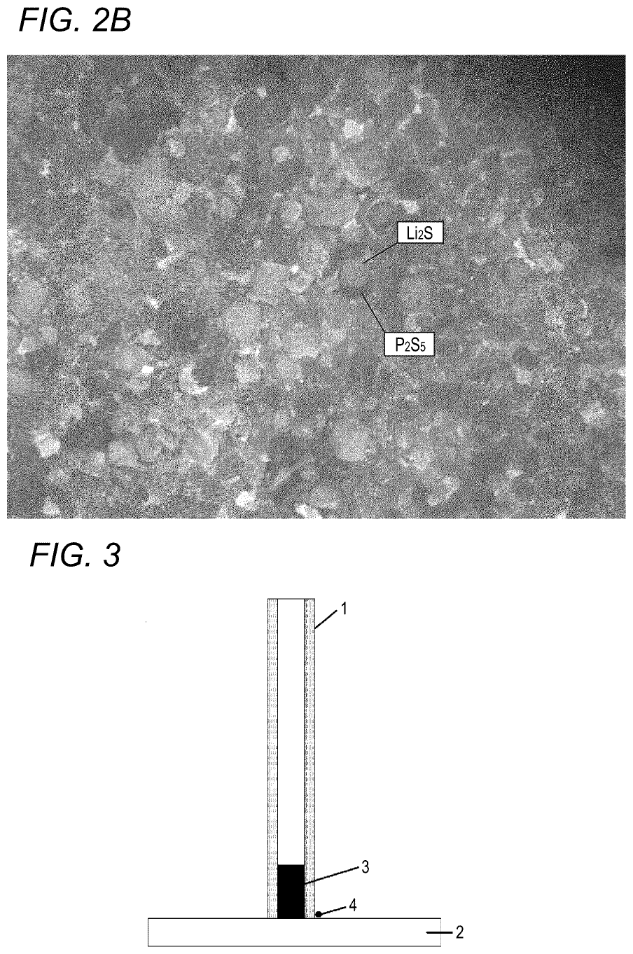

In order to simulate the case where mixed raw materials in each example are charged into the heated furnace from a furnace supply portion, as shown in FIG. 3, first, a metal pipe 1 was vertically erected on a hot plate 2, and held such that an end portion thereof was in contact with a hot plate heating surface. Subsequently, mixed raw materials 3 in each example were charged from an upper portion of the metal pipe 1, and the hot plate 2 was heated. A thermocouple 4 was installed at a lower end portion of the metal pipe 1, and the temperature of the lower end portion was measured. After heating, a nitrogen gas adjusted to a pressure of 0.1 MPa was supplied from the upper portion, and the temperature of the lower end portion of the metal pipe 1 when the nitrogen gas flow was disabled was measured.

### Example 1

### (Pulverization of Li₂S)

First, in order to reduce the diameter of Li₂S, a Li₂S raw material was pulverized under conditions at a rotation speed of 24,000 rpm for 300 sec using MX1100X™ manufactured by WARING. The D50 of the pulverized Li₂S in the volume-based particle diameter distribution was measured by a laser diffraction particle size distribution measurement method using MT3000II manufactured by Microtrac, using dibutyl ether as a measurement solvent, at a particle refractive index of 1.81 and a solvent refractive index of 1.353, and the D50 was 12 μm.

### (Mixing of Raw Materials)

In a glove box adjusted to a nitrogen atmosphere environment at a dew point of −50° C., raw material powders of pulverized Li₂S, P₂S₅, and LiCl were blended in order at a molar ratio of 1.9:0.5:1.6, and sufficiently stirred and mixed to obtain a mixture of sulfide solid electrolyte raw materials in Example 1.

The D50 of the P₂S₅ in the volume-based particle diameter distribution used above was measured by a laser diffraction particle size distribution measurement method using MT3000II manufactured by Microtrac, using dibutyl ether as a measurement solvent, at a particle refractive index of 1.81 and a solvent refractive index of 1.353, and the D50 was 230 μm.

### Example 2

A mixture of sulfide solid electrolyte raw materials in Example 2 was obtained in the same manner as in Example 1 except that the Li₂S raw material was passed through a sieve having a mesh of 100 μm, and the Li₂S raw material having a D50 of 70 μm in a volume-based particle diameter distribution as measured by a laser diffraction particle size distribution measurement method using MT3000II manufactured by Microtrac, using dibutyl ether as a measurement solvent, at a particle refractive index of 1.81 and a solvent refractive index of 1.353, was used.

### Example 3

A mixture of sulfide solid electrolyte raw materials in Example 3 was obtained in the same manner as in Example 1 except that the Li₂S raw material having a D50 of 720 μm in a volume-based particle diameter distribution as measured by a laser diffraction particle size distribution measurement method using MT3000II manufactured by Microtrac, using dibutyl ether as a measurement solvent, at a particle refractive index of 1.81 and a solvent refractive index of 1.353, was used.

### Example 4

A mixture of sulfide solid electrolyte raw materials in Example 4 was obtained in the same manner as in Example 1 except that the Li₂S raw material and the P₂S₅ raw material were passed through a sieve having a mesh of 500 μm, and the Li₂S raw material and the P₂S₅ raw material having a D50 of 365 μm and 150 μm, respectively, in a volume-based particle diameter distribution as measured by a laser diffraction particle size distribution measurement method using MT3000II manufactured by Microtrac, using dibutyl ether as a measurement solvent, at a particle refractive index of 1.81 and a solvent refractive index of 1.353, were used.

Table 1 summarizes the temperature at the time of clogging and the like in each example.

TABLE 1

| | Li₂S particle | P₂S₅ particle | Temperature at the |
|---|---|---|---|
| | diameter (D50) | diameter (D50) | time of clogging |
| Example 1 | 12 μm | 230 μm | 220° C. |
| Example 2 | 70 μm | 230 μm | 160° C. |
| Example 3 | 720 μm | 230 μm | 70° C. |
| Example 4 | 365 μm | 150 μm | 70° C. |

As can be seen from the results shown in Table 1, in Examples 1 and 2, since the D50 of Li₂S was smaller than the D50 of P₂S₅ in the mixture of raw material powders, the temperature at the time of clogging was high. This indicates that the sulfide solid electrolyte can be synthesized while preventing the aggregation and clogging due to the raw materials. That is, as shown in FIG. 2A, it is believed that a large amount of Li₂S particles can be brought into contact with the surfaces of the P₂S₅ particles in the present mixture, or the surfaces of the P₂S₅ particles can be coated with the Li₂S particles, thereby suppressing contact between the P₂S₅ particles and causing the Li₂S particles which have a relatively high melting point to come into contact with each other, so that the aggregation of the raw material particles can be prevented, and thus the clogging of the supply portion or the like can be prevented.

On the other hand, in Examples 3 and 4, since the D50 of Li₂S is larger than the D50 of P₂S₅ in the mixture of raw material powders, the temperature at the time of clogging is low. This indicates that the aggregation and clogging due to the raw materials cannot be sufficiently prevented. That is, as shown in FIG. 2B, it is believed that since the particle diameter of the Li₂S particles is large, the Li₂S particles cannot be sufficiently brought into contact with the surfaces of the P₂S₅ particles in the present mixture or the surfaces of the P₂S₅ particles cannot be coated with the Li₂S particles, and thus the aggregation of the raw material particles cannot be sufficiently prevented.

Although various embodiments have been described above, it is needless to say that the present invention is not limited to such examples. It is obvious for a person skilled in the art that various modifications and variations can be made within the scope of claims and it is understood that such modifications and variations naturally belong to the technical scope of the present invention. Further, the components described in the above embodiment may be combined in any manner without departing from the gist of the invention.

The present application is based on a Japanese Patent Application (No. 2023-119362) filed on Jul. 21, 2023, the content of which is incorporated herein by reference.

What is claimed is:

1. A mixture of sulfide solid electrolyte raw materials comprising Li₂S and P₂S₅,
wherein A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.

2. The mixture of sulfide solid electrolyte raw materials according to claim 1, wherein A/B≤0.5 is satisfied.

3. The mixture of sulfide solid electrolyte raw materials according to claim 1, wherein B≥50 μm is satisfied.

4. A method for producing a sulfide solid electrolyte, comprising:
charging sulfide solid electrolyte raw materials into a heated furnace and performing mixing to obtain a mixture of the sulfide solid electrolyte raw materials, or charging a mixture of sulfide solid electrolyte raw materials into a heated furnace; and
heating and melting the mixture of sulfide solid electrolyte raw materials, and cooling and solidifying a resulting melt to obtain a sulfide solid electrolyte,
wherein the mixture of sulfide solid electrolyte raw materials comprises Li₂S and P₂S₅, and
A<B is satisfied, where A is a volume-based average particle diameter of the Li₂S as measured by using a laser diffraction particle size distribution measurement method, and B is a volume-based average particle diameter of the P₂S₅ as measured by using the laser diffraction particle size distribution measurement method.

5. The method for producing a sulfide solid electrolyte according to claim 4, wherein A/B≤0.5 is satisfied.

6. The method for producing a sulfide solid electrolyte according to claim 4, wherein B≥50 μm is satisfied.

7. The method for producing a sulfide solid electrolyte according to claim 4, wherein the sulfide solid electrolyte raw materials or the mixture of sulfide solid electrolyte raw materials is continuously charged into the heated furnace, heated and melted, and the resulting melt is continuously discharged to continuously obtain the sulfide solid electrolyte.

8. The method for producing a sulfide solid electrolyte according to claim 4, wherein a sulfur source is supplied into the melt obtained by heating and melting the mixture of sulfide solid electrolyte raw materials.

9. The method for producing a sulfide solid electrolyte according to claim 4, wherein a sulfur source is incorporated into the mixture of sulfide solid electrolyte raw materials, followed by heating and melting.

10. The method for producing a sulfide solid electrolyte according to claim 4, wherein the mixture of sulfide solid electrolyte raw materials is heated and melted at 600° C. or higher.
